(19) United States
(12) Patent Application Publication
(10) Pub. No.: US 2025/0054281 A1
(43) Pub. Date: Feb. 13, 2025

(54) METHOD AND APPARATUS FOR DATA AUGMENTATION BASED ON OUTPAINTING

(71) Applicant: Electronics and Telecommunications Research Institute, Daejeon (KR)

(72) Inventors: Sung Won MOON, Daejeon (KR); Do Won NAM, Daejeon (KR); Won Young YOO, Daejeon (KR); Jung Soo LEE, Daejeon (KR); Ji Won LEE, Daejeon (KR)

(21) Appl. No.: 18/610,149

(22) Filed: Mar. 19, 2024

(30) Foreign Application Priority Data
Aug. 10, 2023 (KR) 10-2023-0104856

(51) Int. Cl. G06V 10/774; G06T 11/00; G06V 10/776

(52) U.S. Cl. CPC G06V 10/774; G06T 11/00; G06V 10/776

(57) ABSTRACT

A method and apparatus for data augmentation based on outpainting is proposed. The method includes receiving input of image information and prompt information by an image processing apparatus, creating training data by using outpainting techniques and performing the data augmentation on the basis of the image information and the prompt information by the image processing apparatus, training an object detection model on the basis of the created training data by the image processing apparatus, evaluating performance of the object detection model by the image processing apparatus, and converting and storing performance evaluation results and the prompt information into a database by the image processing apparatus.

### CROSS REFERENCE TO RELATED APPLICATION

The present application claims priority to Korean Patent Application No. 10-2023-0104856, filed Aug. 10, 2023, the entire contents of which are incorporated herein for all purposes by this reference.

### BACKGROUND OF THE INVENTION

### Field of the Invention

The technology described below relates to a method for augmenting data by using outpainting.

### Description of the Related Art

Machine learning-based models are models for processing given tasks by inferring patterns from input data. An artificial neural network (ANN)-based model that mimics a human neural network is also one of the machine learning models. The machine learning-based models are also used as artificial intelligence models.

In order to build a machine learning-based model, a large amount of training data is required. In a case when there is insufficient training data for building the model, problems such as overfitting may occur. Accordingly, a data augmentation technique and the like are used to secure sufficient training data. The data augmentation technique is one of the methods to increase the size of a data set by modifying the training data that is retained. For example, the data augmentation technique includes techniques such as rotating, cropping, color changing, mixing up, or mosaicing of images.

### DOCUMENTS OF RELATED ART

### Patent Document

Korean Patent Application Publication No. 10-2022-0128114

### SUMMARY OF THE INVENTION

Conventionally used data augmentation techniques have helped improve the performance of artificial intelligence models. However, the existing data augmentation techniques are fundamentally unable to specify and augment data having a form insufficient for users. In addition, in a case where an object within an image is dominant in training data (e.g., when a size of the object is very large compared to that of the entire image), training an artificial intelligence model for detecting a small object is relatively difficult.

The technology described below provides a method for creating training data through a method for data augmentation by using an outpainting technique. In addition, the technology described below provides a method for converting the performance of prompt used for the data augmentation into a database.

A method for data augmentation based on outpainting includes the following: receiving, by an image processing apparatus, input of image information and prompt information; creating, by the image processing apparatus, training data by using outpainting techniques and performing the data augmentation on the basis of the image information and the prompt information; training, by the image processing apparatus, an object detection model on the basis of the created training data; evaluating, by the image processing apparatus, performance of the object detection model; and converting and storing, by the image processing apparatus, performance evaluation results and the prompt information into a database.

When the technology described below is used, a size and a position of an object in an image may be adjusted, so as to generate various types of images, whereby data may be augmented. When the technology described below is used, prompts used for data augmentation and the performance of a trained object detection model may be converted into a database. When the technology described below is used, prompts for creating efficient training data may be identified through the built database.

### BRIEF DESCRIPTION OF THE DRAWINGS

FIG. 1 is a view illustrating a process in which an image processing apparatus 100 performs a method for data augmentation based on outpainting.

FIG. 2 is a flowchart 200 illustrating one of exemplary embodiments of the method for data augmentation based on outpainting.

FIG. 3 is a view illustrating one of exemplary embodiments in which the image processing apparatus creates training data.

FIG. 4 illustrates exemplary embodiments of de-noising.

FIG. 5 is a view illustrating a configuration of one of the exemplary embodiments of the image processing apparatus.

### DETAILED DESCRIPTION OF THE INVENTION

The technology described below may be applied with various changes and may have various exemplary embodiments. The drawings in the specification may describe specific exemplary embodiments of the technology described below. However, this is for explanation of the technology described below and is not intended to limit the technology described below to the specific exemplary embodiments. Therefore, it should be understood that all changes, equivalents, or substitutes included in the idea and technical scope of the technology described below are included in the technology described below.

In the terms used below, singular expressions should be understood to include plural expressions unless the context clearly interprets otherwise. It should be understood that the term “includes”, “comprises”, or the like mean that the described feature, number, step, operation, component, part, or combination thereof exists, but do not preclude possibilities of the presence or addition of one or more other features or numbers, steps, operations, components, parts, or combinations thereof.

Prior to a detailed description of the drawings, it should be clarified that the classification of components in the present specification is merely a classification for each main function of each corresponding component. That is, it may be provided such that two or more components described below may be combined into one component, or one component may be divided into two or more components for each more subdivided function. Further, in addition to its main functions in charge, each component to be described below may additionally perform some or all of the functions of other components in charge, and naturally, some of the main functions of each component in charge may also be exclusively performed by other components.

In addition, in performing a method or method of operation, each process constituting the method may be performed in a different order from a specified order unless a specific order is clearly described in context. That is, each process may be performed in the same order as specified, may be performed substantially simultaneously, or may be performed in a reverse order.

Hereinafter, the overall process in which an image processing apparatus performs a method for data augmentation based on outpainting will be described.

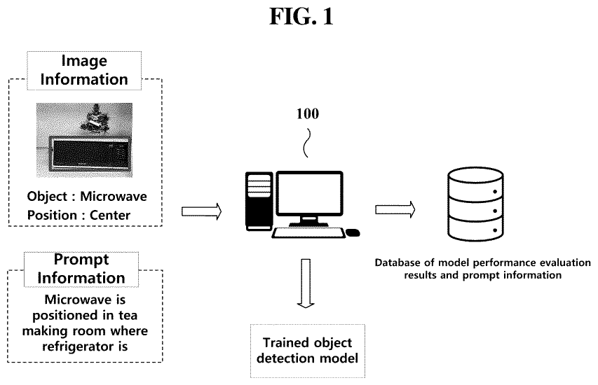

FIG. 1 is a view illustrating a process in which the image processing apparatus 100 performs the method for data augmentation based on outpainting.

The image processing apparatus 100 may receive input of image information and prompt information. The image processing apparatus 100 may create training data by using outpainting techniques and performing data augmentation on the basis of the image information and the prompt information. The image processing apparatus 100 may train an object detection model on the basis of the created training data. The image processing apparatus 100 may evaluate the performance of the object detection model. The image processing apparatus 100 may convert and store performance evaluation results and the prompt information in a database.

Hereinafter, the method for data augmentation based on outpainting will be described in detail.

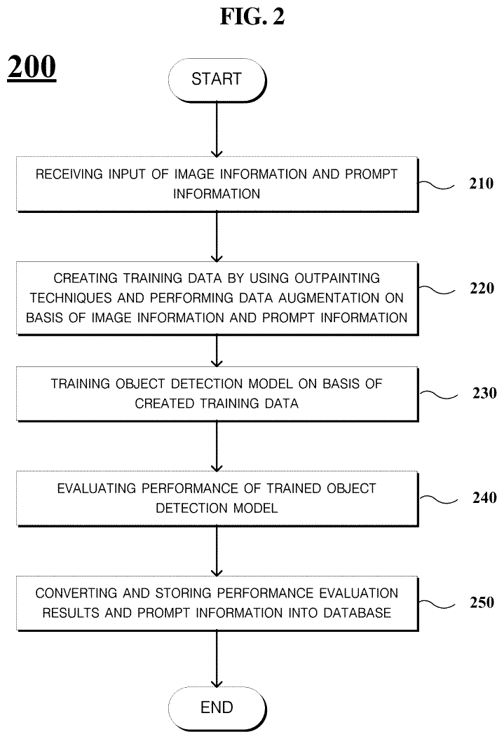

FIG. 2 is a flowchart 200 illustrating one of exemplary embodiments of the method for data augmentation based on outpainting.

In step 210, an image processing apparatus may receive input of image information and prompt information.

The image information may include an image, and information about a type of an object included in the image and a position of the object included in the image. For example, the image information may include a photo (i.e., an image) of the sea and a warship, information that an object included in the photo is the warship, and the fact that the warship, which is the object included in the photo, is positioned in a lower right end of the image.

The information about the position of the object may include information about a position or size of a bounding box containing the object. For example, the information about the position of the object may include coordinates for vertices of the bounding box containing the object. Alternatively, the information about the position of the object may include the x and y coordinates of an upper left pixel and the x and y coordinates of a lower right pixel of the bounding box containing the object. Alternatively, the information about the position of the object may include the x and y coordinates of the upper left pixel of the bounding box containing the object, and the horizontal and vertical sizes of the bounding box. Alternatively, the information about the position of the object may include the x and y coordinates of a center point of the bounding box containing the object and the horizontal and vertical sizes of the bounding box.

The prompt information may be used to control artificial intelligence model to generate output. The prompt information may in be text form converted from any other form.

The prompt information may refer to information that is input to an artificial intelligence model, such as a generative model, in order to obtain required outputs. That is, the artificial intelligence model may generate images, paragraphs, voices, etc. on the basis of the input prompt information. In one exemplary embodiment, in a case of a model for generating an image from text, prompt information may mean text input to the model in order to generate the image. In one exemplary embodiment, the prompt information may include information about a size, a position, and an attribute of a desired object and an atmosphere, a situation, and the like of a desired image. For example, the prompt information may include text of “An image of a spaceship moving within a Van Gogh-style space background”.

In step 220, the image processing apparatus may create training data by using outpainting techniques and performing data augmentation on the basis of the image information and prompt information.

Outpainting is one of the methods for generating an outer side area of an input image. That is, the outpainting is generally a method of adding content, which was not present in an original image, by generating the outer side area of the image. For example, an image obtained by photographing a part of the face of a person may be used to fill the rest part of the face of the person.

Outpainting may be performed through an artificial neural network-based model. Specifically, outpainting may be performed through a generative model. In one exemplary embodiment, outpainting may be performed by using a model based on a generative adversarial network (GAN). Alternatively, the outpainting may be performed by using a model based on Stable Diffusion. A Stable Diffusion model is one of the models based on artificial neural networks, and may be a model for receiving text as input and generating an image (i.e., a text-to-image model).

Outpainting may be performed on the basis of prompt information. In one exemplary embodiment, in a case where the prompt information is text of “An image of a seagull flying at a port near a beach”, an outer side area of an input image may be generated on the basis of this information.

The created training data may be used to train an object detection model. A large number of different images may be generated from one image through outpainting, thereby being useful for training the object detection model.

The created training data may include information about an image generated through the outpainting techniques, a type of an object included in the image, and a position of the object included in the image. The created training data is reference data, and may include the information about the type of the object included in the image and the position of the object included in the image.

The created training data may undergo a de-noising process. Specifically, the de-noising process may include a process of removing artificial noise (i.e., artifacts) from the created training data, which is invisible to human eyes but may also cause the object detection model to train incorrectly. Specifically, the de-noising process may be similar to a process of removing sensor noise generated during camera shooting, etc. That is, the de-noising process may include a process of checking and removing Gaussian noise, uniform noise, etc.

In step 230, the image processing apparatus may train the object detection model on the basis of the created training data.

The object detection model may refer to a model for detecting an object in an image. Specifically, after detecting the object in the image, the object detection model may include information about what type of the object it is or where the object is positioned.

The object detection model may be an artificial neural network-based model. In one exemplary embodiment, the object detection model may be a conventionally known model such as YOLO (You only Look Once), region-based convolutional neural networks (R-CNN), or RetinaNet. Alternatively, the object detection model may also be a model based on DAMO-YOLO.

In step 240, the image processing apparatus may evaluate the performance of the trained object detection model.

The performance evaluation of the object detection model may be performed on the basis of various indices. Specifically, conventional indices used to evaluate how well an object detection model detects objects may be used. In one exemplary embodiment, the performance evaluation of the object detection model may be performed on the basis of Precision and Recall of a model. In one exemplary embodiment, the performance evaluation of the object detection model may be performed on the basis of intersection over union (IoU). In one exemplary embodiment, the performance evaluation of the object detection model may be performed on the basis of mean average precision (mAP).

In step 250, the image processing apparatus may convert and store performance evaluation results and the prompt information in a database.

The evaluated performance results and the prompt information may be recorded in a database. Specifically, the database may store information on how well the object detection model perform when the object detection model is trained on the basis of the training data created by using certain prompt information and performing outpainting with an image. Accordingly, when the created database is used, it is determinable that using which prompt may cause the performance of the object detection model to be improved. Based on this, an appropriate prompt may be selected in training the object detection model thereafter.

Alternatively, the created training data may be further recorded in the database. Accordingly, it is possible to check that which training data provides good performance evaluation results for the object detection model. In this way, the training data useful for training the object detection model may be checked so as to train another object detection model.

Furthermore, the image processing apparatus may list the prompt information in order of higher to lower performance evaluation results in the database and then output the prompt information to a user. In this way, the user may know which prompt information to use for performing efficient data augmentation.

Hereinafter, an exemplary embodiment in which an image processing apparatus creates training data.

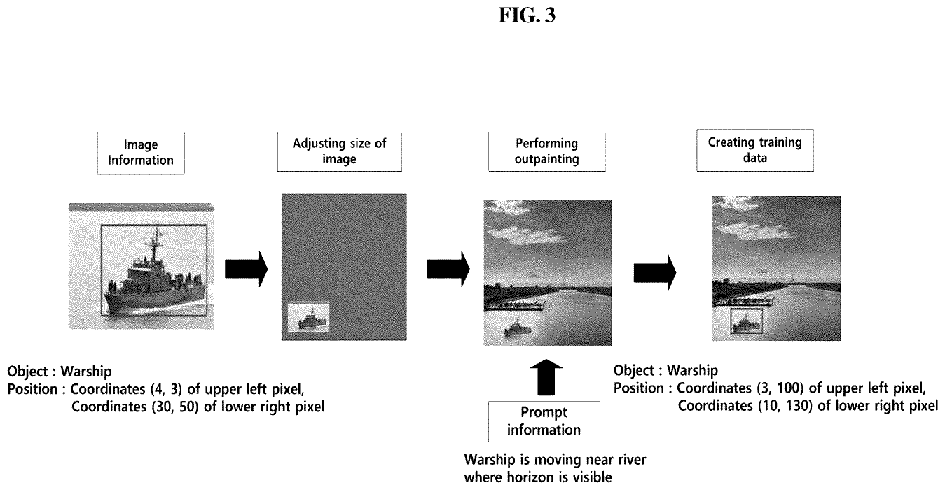

FIG. 3 is a view illustrating one of exemplary embodiments in which the image processing apparatus creates training data.

The image processing apparatus may receive input of image information. The image information may include an image of a warship floating in the sea and information that an object shown in the image is the warship. In addition, the image information may include information about a position of the object, which is called the warship and contained in a bounding box of which the x and y coordinates of an upper left pixel are (3,4) and the x and y coordinates of a lower right pixel are (30,50).

The image processing apparatus may adjust a size of an input image. Accordingly, the size of the input image is reduced and then placed at a bottom left end.

The image processing apparatus may receive input of prompt information such as “A warship is moving near a river where the horizon is visible.”

Through outpainting, the image processing apparatus may generate an outer side area of the input image on the basis of the size-adjusted image and the prompt information. Accordingly, an image for the rest portion of the input image is generated.

The image processing apparatus may create the training data on the basis of the results of outpainting. In this case, reference data may include the fact that the object shown in the image is the warship, and the fact that the bounding box containing the object called the warship has the x and y coordinates (3, 100) of an upper left pixel and the x and y coordinates (10, 130) of a lower right pixel. The created training data may be used to train the object detection model.

Hereinafter, one of exemplary embodiments of a de-noising process will be described.

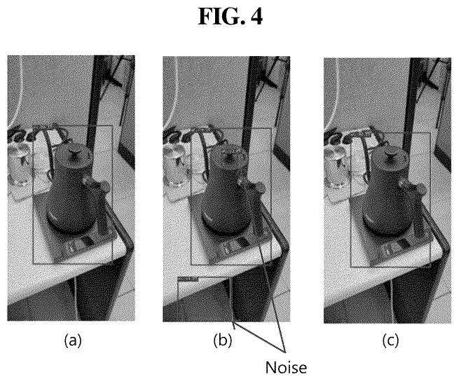

FIG. 4 illustrates exemplary embodiments of de-noising.

A part (a) of FIG. 4 illustrates a situation in which an object is detected when a person looks at an image. That is, when the person looks at the image, he or she may recognize that there is the object called a coffee pot in the center of the image. Accordingly, an object detection model is also required to be trained so as to recognize that there is the object called the coffee pot in the center of the image, as shown in the part (a) of FIG. 4.

A part (b) of FIG. 4 may be a result of an image processing apparatus displaying the object from training data created through data augmentation. The image processing apparatus may accurately annotate the object such as the coffee pot positioned in the center of the image, but may detect and annotate an object (i.e., noise) at a wrong spot as well. Such noise may occur during a process where the image processing apparatus performs the data augmentation to create the training data. Although such noise is invisible to the human eyes, it may affect the object detection model to train incorrectly during the training process.

A part (c) of FIG. 4 illustrates a result of removing the noise from the created training data. As a result of removing the noise, the object called the coffee pot positioned in the center of the image is accurately annotated. When the object detection model is trained by using the training data with the noise removed, a model may be trained so as to correctly detect objects.

Hereinafter, the image processing apparatus will be described.

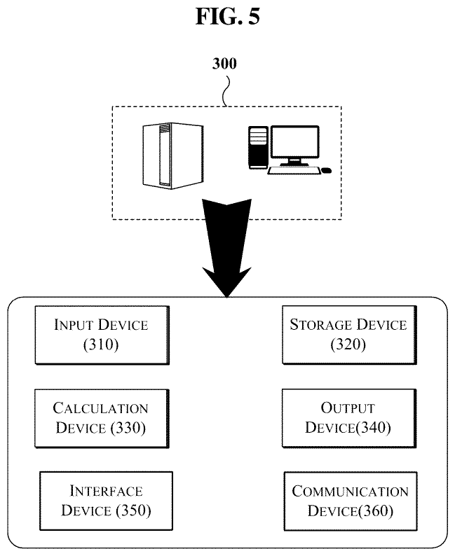

FIG. 5 is a view illustrating a configuration of one of exemplary embodiments of the image processing apparatus.

The image processing apparatus 300 may correspond to the image processing apparatus 100 described in FIG. 1. The image processing apparatus 300 may be an apparatus for performing the above-described method for data augmentation based on outpainting.

The image processing apparatus 300 may be physically implemented in various forms. For example, the image processing apparatus 300 may have a form of a personal computer (PC), a laptop computer, a smart device, a server, or a chipset dedicated to data processing.

The image processing apparatus 300 may include an input device 310, a storage device 320, a calculation device 330, an output device 340, an interface device 350, and a communication device 360.

The input device 310 may also include an interface device (i.e., a keyboard, a mouse, a touch screen, etc.) for receiving predetermined commands or data. The input device 310 may also include a component for receiving information through a separate storage device (i.e., a USB, a CD, a hard disk, etc.). The input device 310 may also receive input data through a separate measurement device or through a separate DB. The input device 310 may receive data through wired or wireless communication.

The input device 310 may receive input of information and a model, which are required to perform the above-described method for data augmentation based on outpainting. The input device 310 may receive input of image information and prompt information.

The storage device 320 may store the input information received through the input device 310. The storage device 320 may store information generated in a process of calculation by the calculation device 330. That is, the storage device 320 may include a memory. The storage device 320 may store a result calculated by the calculation device 330.

The storage device 320 may store the information and model, which are required to perform the above-described method for data augmentation based on outpainting. The storage device 320 may store the image information and the prompt information. The storage device 320 may store the created training data. The storage device 320 may store a database.

The calculation device 330 may be a device such as a processor, an AP, or a chip having an embedded program, which are configured to process data and perform predetermined calculation.

The calculation device 330 may generate a control signal for controlling the image processing apparatus.

The calculation device 330 may perform calculations required to perform the above-described method for data augmentation based on outpainting. The calculation device 330 may create training data by using outpainting techniques and performing the data augmentation on the basis of the image information and the prompt information. The calculation device 330 may train an object detection model on the basis of the created training data. The calculation device 330 may evaluate the performance of the object detection model. The calculation device 330 may convert performance evaluation results and prompt information into a database. The calculation device 330 may list the prompt information in the database in order of higher to lower performance evaluation results.

The output device 340 may be a device for outputting predetermined information. The output device 340 may also output an interface required for data processing, input data, analysis results, and the like. The output device 340 may also be physically implemented in various forms, such as a display, a device for outputting documents, and the like. The output device 340 may output the prompt information in the database in order of higher to lower performance evaluation results.

The interface device 350 may be a device for receiving predetermined commands and data from the outside. The interface device 350 may receive input of the information and model, which are required to perform the above-described method for data augmentation based on outpainting, from an input device or external storage device physically connected thereto. The interface device 350 may receive input of a control signal for controlling the image processing apparatus 300. The interface device 350 may output a result analyzed by the image processing apparatus 300.

The communication device 360 may refer to a component for receiving and transmitting predetermined information through a wired or wireless network. The communication device 360 may receive a control signal required to control the image processing apparatus 300. The communication device 360 may transmit the result analyzed by the image processing apparatus 300.

The above-described method for data augmentation based on outpainting may be implemented as a program (or an application) including an algorithm executable on a computer.

The program may be stored and provided in a transitory or non-transitory computer readable medium.

The non-transitory computer readable medium is not a medium for storing data for a short moment, such as a register, a cache, a memory, and the like, but is a medium for storing data semi-permanently and readable by a device. Specifically, the various applications or programs described above may be stored and provided in the non-transitory computer readable medium such as a CD, a DVD, a hard disk, a Blu-ray disk, a USB, a memory card, a read-only memory (ROM), a programmable read only memory (PROM), an erasable PROM (EPROM) or an electrically EPROM (EEPROM), or a flash memory.

The transitory computer readable medium refers to various random access memories (RAMs) such as a static RAM (SRAM), a dynamic RAM (DRAM), a synchronous DRAM (SDRAM), a double data rate SDRAM (DDR SDRAM), an enhanced SDRAM (ESDRAM)), a Synclink DRAM (SLDRAM)), and a direct Rambus RAM (DRRAM).

The present exemplary embodiment and the accompanying drawings in the present specification only clearly show a part of the technical idea included in the above-described technology, and it will be apparent that all modifications and specific exemplary embodiments that may be easily inferred by those skilled in the art within the scope of the technical spirit contained in the specification and drawings of the above-described technology are included in the scope of the above-described technology.

What is claimed is:

1. A method for data augmentation based on outpainting, the method comprising:
receiving, by an image processing apparatus, input of image information and prompt information;
creating, by the image processing apparatus, training data by using outpainting techniques and performing the data augmentation on the basis of the image information and the prompt information;
training, by the image processing apparatus, an object detection model on the basis of the created training data;
evaluating, by the image processing apparatus, performance of the object detection model; and
converting and storing, by the image processing apparatus, performance evaluation results and the prompt information into a database.

2. The method of claim 1, wherein the image information comprises information about an image, a type of an object contained in the image, and a position of the object contained in the image.

3. The method of claim 1, wherein the outpainting is performed by using an artificial neural network-based model, and
the artificial neural network-based model is a Stable Diffusion-based model.

4. The method of claim 1, wherein the training data is reference data and comprises information about a type of an object contained in the image and a position of the object contained in the image.

5. The method of claim 1, further comprising:
listing, by the image processing apparatus, the prompt information in order of higher to lower performance evaluation results in the database, and then outputting the prompt information to a user.

6. The method of claim 1, wherein the evaluating of the performance of the object detection model comprises evaluating the performance of the object detection model by using at least one of Precision, Recall, intersection over union (IoU), and mean average precision (mAP) as an evaluation index.

7. The method of claim 1, wherein the image processing apparatus further records the created training data in the database.

8. The method of claim 1, further comprising:
performing, by the image processing apparatus, de-noising for removing noise contained in the created training data.

9. An apparatus for data augmentation based on outpainting, the apparatus comprising:
an input device configured to receive input of image information and prompt information;
a calculation device configured to create training data by using outpainting techniques and performing the data augmentation on the basis of the image information and the prompt information, train an object detection model on the basis of the created training data, evaluate performance of the object detection model, and convert performance evaluation results and the prompt information into a database; and
a storage device configured to store the image information, the prompt information, and the database.

10. The apparatus of claim 9, wherein the image information comprises information about an image, a type of an object contained in the image, and a position of the object contained in the image.

11. The apparatus of claim 9, wherein the calculation device performs the outpainting by using an artificial neural network-based model, and
the artificial neural network-based model is a Stable Diffusion-based model.

12. The apparatus of claim 9, wherein the training data is reference data and comprises information about a type of an object contained in the image and a position of the object contained in the image.

13. The apparatus of claim 9, further comprising:
an output device configured to output the prompt information listed in order of higher to lower evaluation results,
wherein the calculation device lists the prompt information in the order of higher to lower performance evaluation results in the database.

14. The apparatus of claim 9, wherein the evaluating of the performance of the object detection model comprises evaluating the performance of the object detection model by using at least one of Precision, Recall, intersection over union (IoU), and mean average precision (mAP) as an evaluation index.

15. The apparatus of claim 9, wherein the calculation device further records the created training data in the database.

16. The apparatus of claim 9, wherein the calculation device performs de-noising for removing noise contained in the created training data
